(19) United States
(12) Patent Application Publication
(10) Pub. No.: US 2026/0186344 A1
(43) Pub. Date: Jul. 2, 2026

(54) DISPLAY APPARATUS HAVING A BACK-LIGHT UNIT

(71) Applicant: LG Display Co., Ltd., Seoul (KR)

(72) Inventors: Ki Sung LIM, Paju-si (KR); Myung Won SEO, Paju-si (KR); Ki Seong KIM, Paju-si (KR)

(73) Assignee: LG Display Co., Ltd., Seoul (KR)

(21) Appl. No.: 19/421,696

(22) Filed: Dec. 16, 2025

(30) Foreign Application Priority Data
Dec. 26, 2024 (KR) 10-2024-0197319
Jun. 26, 2025 (KR) 10-2025-0085258

(51) Int. Cl. G02F 1/1335; G02F 1/13357

(52) U.S. Cl. CPC G02F 1/133614; G02F 1/133606

(57) ABSTRACT

A display apparatus including a back-light unit is provided. The back-light unit can provide light to a liquid crystal panel. For example, the back-light unit can include blue light-sources disposed side by side on the optical substrate. A color conversion sheet can be sequentially stacked on the blue light-sources. The color conversion sheet can emit light displaying a color other than a blue color in all directions by using blue light emitted from the blue light-sources. The blue light can be diffused in all directions by the color conversion sheet. Thus, in the display apparatus, the occurrence of spots due to the difference in the travelling direction of the blue light and the light display a color other than the blue color can be prevented.

### CROSS-REFERENCE TO RELATED APPLICATIONS

This application claims the benefit of Korean Patent Applications No. 10-2024-0197319, filed on Dec. 26, 2024, and No. 10-2025-0085258, filed on Jun. 26, 2025, which are hereby incorporated by reference as if fully set forth herein.

### BACKGROUND

### Technical Field

The present disclosure relates to a display apparatus generating an image by using light emitted from a back-light unit.

### Discussion of the Related Art

Generally, a display apparatus provides an image to a user. For example, the display apparatus can include a liquid crystal panel disposed on a back-light unit. The liquid crystal panel can realize the image by using light provided from the back-light unit.

The back-light unit can include a light-source unit emitting light. The light emitted from the light-source unit can display a specific color. For example, the light-source unit can include blue light-sources emitting blue light. White light can be provided to the liquid crystal panel. For example, the back-light unit can include a color conversion sheet between the light-source unit and the liquid crystal panel.

A plurality of light-emitting elements can be dispersed within the color conversion sheet. Each of the light-emitting elements can emit light displaying a color other than a blue color by using the blue light emitted from the light-source unit. For example, the plurality of light-emitting elements can include red light-emitting elements emitting red light by using the blue light and green light-emitting elements emitting green light by using the blue light.

### SUMMARY

Accordingly, embodiments of the present disclosure are directed to a display apparatus that substantially obviates one or more problems due to limitations and disadvantages of the related art.

An object of the present disclosure is to reduce the number of light-emitting diodes (LED) in a back-light unit or, in other words, increase the pitch of the LEDs (i.e. the distance between the LEDs) in the back-light unit. This allows to significantly reduce the size, in particular the thickness, of the back-light unit.

Another aspect of the present disclosure is to provide a display apparatus capable of reducing or minimizing the difference in the luminance of the light provided to the display panel from the back-light unit.

Another aspect of the present disclosure is to provide a display apparatus capable of preventing the occurrence of the spots due to the location of the light-sources emitting light toward the display panel.

Additional advantages, objects, and features of the disclosure will be set forth in part in the description which follows and in part will become apparent to those having ordinary skill in the art upon examination of the following or may be learned from practice of the disclosure. The objectives and other advantages of features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these objects and other advantages and in accordance with the purpose of the present disclosure, as embodied and broadly described herein, there is provided a display apparatus comprising a light-source unit including blue light-sources, which are disposed side by side, a light-blocking sheet including light-blocking patterns, a color conversion sheet on the blue light-sources of the light-source unit, at least one optical sheet on the color conversion sheet, a display panel on the at least one optical sheet, and a diffusion plate including a plurality of diffusion patterns.

The color conversion sheet includes blue light-emitting bodies and the distance between adjacent blue light-sources is higher than the distance between two adjacent light-blocking patterns.

The light-blocking patterns overlap the blue light-sources.

It should be noted that the light-blocking patterns overlapping with the blue light-sources can be understood to mean that the light-blocking patterns are at least partially located in a direction perpendicular to the upper surface of the light-source substrate from the blue light-sources. Similarly, when herein it is stated that a first component overlaps (or overlaps with) a second component, this may be understood as the first component being located at least partially in a direction perpendicular to the upper surface of the light-source substrate from the second component. In other words, the projections of the two components along the direction perpendicular to the upper surface of the light-source substrate overlap.

The light-emitting layer may include a blue emission material and a core particle surrounded by the blue light-emitting layer.

The blue emission material may include a blue fluorescent material.

The distance between adjacent blue light-sources may be higher than 4 mm.

The light-source unit may include reflective patterns disposed between the blue light-sources.

The distance between two adjacent light-blocking patterns may be smaller than the width of the reflective patterns.

The diffusion patterns may overlap the reflective patterns.

The diffusion patterns may overlap the blue light-source.

The diffusion patterns may overlap the light-blocking patterns.

The color conversion sheet may overlap the diffusion patterns.

The color conversion sheet may include red light-emitting bodies made of a red emission material and green light-emitting bodies made of a green emission material.

The red emission material may include a red fluorescent material.

The green emission material may include a green fluorescent material.

The blue emission material contained in the color conversion sheet may have a content of more than 0% and less than 10%.

The light-source unit may include a light-source planarization layer covering the blue light-sources and the color conversion sheet may be spaced apart from the light-source planarization layer.

The light-blocking sheet may be disposed between the light-source planarization layer and the color conversion sheet wherein the light-blocking sheet includes light-blocking patterns overlapping with the blue light-sources and a light-blocking substrate supporting the light-blocking patterns, and wherein the light-blocking patterns (222) of the light-blocking sheet are covered by the color conversion sheet.

According to another embodiment, to achieve these and other aspects of the inventive concepts, as embodied and broadly described herein, a display apparatus comprises a light-source unit. The light-source unit includes blue light-sources, which are disposed side by side. A color conversion sheet is disposed on the blue light-sources of the light-source unit. At least one optical sheet is disposed on the color conversion sheet. A display panel is disposed on the at least one optical sheet. A blue emission sheet is disposed between the light-source unit and the color conversion sheet. The blue emission sheet includes blue light-emitting elements. Each of the blue light-emitting elements includes a core particle and a blue light-emitting layer. The core particle is surrounded by the blue light-emitting layer. The blue light-emitting layer includes a blue emission material.

The blue emission material can include a blue fluorescent material.

The color conversion sheet can include red light-emitting elements and green light-emitting elements. Each of the red light-emitting elements can be made of a red emission material. Each of the green light-emitting elements can be made of a green emission material.

The red emission material can include a red fluorescent material.

The green emission material can include a green fluorescent material.

The blue emission material contained in the blue emission sheet can have the content of more than 0% and less than 10%.

The blue light-sources can be covered by a light-source planarization layer. The blue emission sheet can be spaced apart from the light-source planarization layer.

A light-blocking sheet can be disposed between the light-source planarization layer and the blue emission sheet. The light-blocking sheet can include a light-blocking substrate and light-blocking patterns. The light-blocking substrate can support the light-blocking patterns. The blue light-sources overlap the light-blocking patterns. The light-blocking patterns can be covered by the blue emission sheet.

In another aspect, a display apparatus comprises a light-source unit. The light-source unit includes a light-source substrate and blue light-sources. The blue light-sources are disposed side by side on the light-source substrate. A display panel is disposed on the blue light-sources of the light-source unit. The display panel is disposed parallel to the light-source substrate. At least one optical sheet is disposed between the blue light-sources and the display panel. A plurality of light-emitting elements is disposed between the light-source substrate and the at least one optical sheet. The plurality of light-emitting elements includes first light-emitting elements and second light-emitting elements. Each of the second light-emitting elements emits light displaying a different color from the first light-emitting elements. Each of the first light-emitting elements includes a core particle and a blue light-emitting layer. A surface of the core particle is covered by the blue light-emitting layer.

The core particle can include an inorganic material. A refractive index of the core particle can be different from a refractive index of the blue light-emitting layer.

A first layer can be disposed between the light-source substrate and the at least one optical sheet. A second layer can be disposed between the first layer and the at least one optical sheet. The second layer can be spaced apart from the first layer. The first light-emitting elements can be dispersed within the first layer. The second light-emitting elements can be dispersed within the second layer.

The blue light-sources of the light-source unit can be covered by the first layer.

A light-blocking sheet can be disposed between the first layer and the second layer. The light-blocking sheet can include a light-blocking substrate and light-blocking patterns. The light-blocking patterns can be disposed side by side on the light-blocking substrate. The light-blocking patterns can overlap the blue light-sources.

A surface of the light-blocking substrate opposite to the light-blocking patterns can be spaced apart from an upper surface of the first layer opposite to the light-source substrate.

The plurality of light-emitting elements can include third light-emitting elements. The third light-emitting elements can emit light displaying a different color from the first light-emitting elements and the second light-emitting elements. Each of the second light-emitting elements and each of the third light-emitting elements can emit light of a longer wavelength than the light by the blue light-emitting layer.

Each of the first light-emitting elements can have a larger size than each second light-emitting element and each third light-emitting element.

It is to be understood that both the foregoing general description and the following detailed description are exemplary and explanatory and are intended to provide further explanation of the inventive concepts as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a view schematically showing a display apparatus according to an embodiment of the present disclosure;

FIG. 2 is a view showing a cross-section taken along I-I′ line of FIG. 1;

FIG. 3 is an enlarged view of K1 region in FIG. 2;

FIG. 4 is a photograph showing blue color provided to the display panel from the back-light unit in a comparative display apparatus that does not include the blue emission sheet and the display apparatus according to the embodiment of the present disclosure;

FIG. 5 is a photograph showing white color provided to the display panel from the back-light unit in a comparative display apparatus that does not include the blue emission sheet and the display apparatus according to the embodiment of the present disclosure;

FIG. 6 is a graph showing the luminance according to the content of the blue emission material contained in the blue emission sheet in the display apparatus according to the embodiment of the present disclosure; and

FIGS. 7 to 19 are views showing the display apparatus according to another embodiment of the present disclosure.

### DETAILED DESCRIPTION

Hereinafter, details related to the above objects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be satisfactorily transferred to those skilled in the art, and thus the present disclosure may be embodied in other forms and is not limited to the embodiments described below.

In addition, the same or extremely similar elements may be designated by the same reference numerals throughout the specification and in the drawings, the lengths and thickness of layers and regions may be exaggerated for convenience. It will be understood that, when a first element is referred to as being “on” a second element, although the first element may be disposed on the second element so as to come into contact with the second element, a third element may be interposed between the first element and the second element.

Here, terms such as, for example, “first” and “second” may be used to distinguish any one element with another element. However, the first element and the second element may be arbitrary named according to the convenience of those skilled in the art without departing the technical sprit of the present disclosure.

The terms used in the specification of the present disclosure are merely used in order to describe particular embodiments, and are not intended to limit the scope of the present disclosure. For example, an element described in the singular form is intended to include a plurality of elements unless the context clearly indicates otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

And, unless ‘directly’ is used, the terms “connected” and “coupled” may include that two components are “connected” or “coupled” through one or more other components located between the two components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

### Embodiment

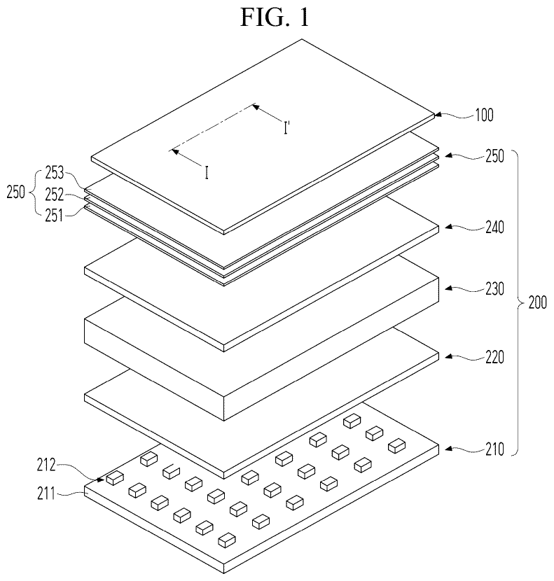

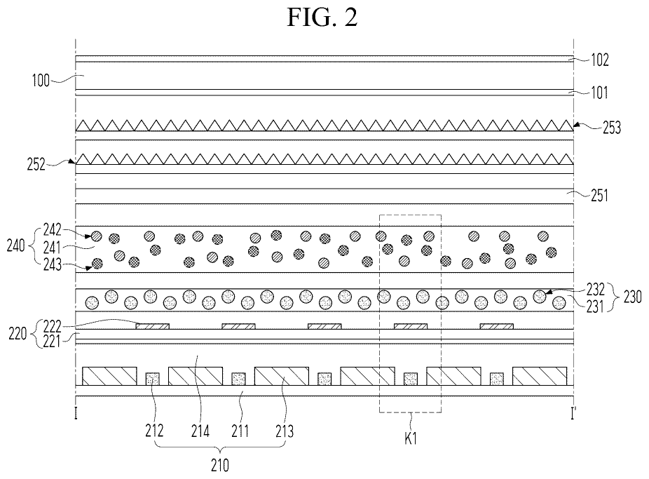

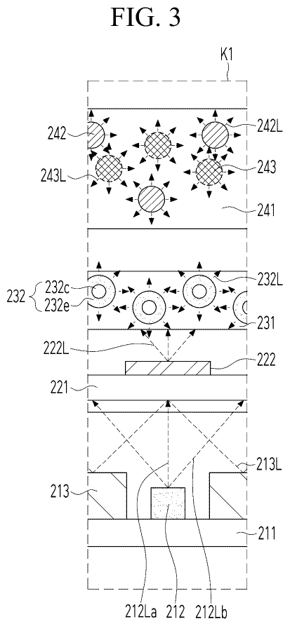

FIG. 1 is a view schematically showing a display apparatus according to an embodiment of the present disclosure. FIG. 2 is a view showing a cross-section taken along I-I′ line of FIG. 1. FIG. 3 is an enlarged view of K1 region in FIG. 2.

Referring to FIGS. 1 to 3, the display apparatus according to the embodiment of the present disclosure can include a display panel 100. The display panel 100 can be disposed on a back-light unit 200. For example, the display panel 100 can be a liquid crystal panel realizing an image provided to a user by using light provided from the back-light unit 200.

The display panel 100 can be disposed between a first linear polarizing plate 101 and a second linear polarizing plate 102. At least one of the first linear polarizing plate 101 and the second linear polarizing plate 102 can be in direct contact with the display panel 100. For example, a lower surface of the display panel 100 toward the back-light unit 200 can be in direct contact with the first linear polarizing plate 101. The second linear polarizing plate 102 can be in direct contact with an upper surface of the display panel 100 opposite to the lower surface of the display panel 100.

A transmittance axis of the second linear polarizing plate 102 can be perpendicular to a transmittance axis of the first linear polarizing plate 101. For example, the display panel 100 can include a pixel electrode, a common electrode and a liquid crystal layer, a liquid crystal particles can be dispersed within the liquid crystal layer disposed parallel to the first linear polarizing plate 101 and the second linear polarizing plate 102, and the liquid crystal particles can be rotated according to an electric field formed by a voltage difference between the pixel electrode and the common electrode. Thus, in the display apparatus according to the embodiment of the present disclosure, the image realized by the display panel 100 can have various luminance and contrast.

The back-light unit 200 providing the light to the display panel 100 can include a light-source unit 210. The light-source unit 210 can emit light displaying a specific color. For example, the light-source unit 210 can include blue light-sources 212 disposed side by side on a light-source substrate 211.

The light-source substrate 211 can include various signal wirings for controlling the blue light-sources 212. For example, the light-source substrate 211 can be a printed circuit board (PCB) in which the signal wirings are formed. The blue light-sources 212 can be mounted on an upper surface of the light-source substrate 211 toward the display panel 100. For example, in the display apparatus according to the embodiment of the present disclosure, the back-light unit 200 can be a direct-type back-light unit in which light by each blue light-source 212 is emitted toward the display panel 100. The light-source substrate 211 can be disposed parallel to the display panel 100.

Each of the blue light-sources 212 can emit blue light. Fo example, each of the blue light-sources 212 can include a blue light-emitting diode (blue LED). Each of the blue light-sources 212 can include a first blue emission material. The first blue emission material can generate light displaying a blue color. For example, the first blue emission material can include a blue fluorescent material.

A light-blocking sheet 220 can be disposed between the light-source unit 210 and the display panel 100. The light-blocking sheet 220 can include a light-blocking substrate 221 and light-blocking patterns 222. The light-blocking substrate 221 can include a material having a high transmittance. For example, the light-blocking substrate 221 can include plastic. The light-blocking substrate 221 can be disposed parallel to the light-source substrate 211. As illustrated in figures, the distance between adjacent blue light-sources 211, 212 is higher than the distance between two adjacent light-blocking patterns 222. Further, as illustrates in the figures, the light-blocking patterns 222 overlap the blue light-sources 212.

The light-blocking patterns 222 can be supported by the light-blocking substrate 221. For example, the light-blocking patterns 222 can be disposed side by side on an upper surface of the light-blocking substrate 221 toward the display panel 100. The light-blocking substrate 221 can be disposed between the blue light-sources 212 and the light-blocking patterns 222. Each of the light-blocking patterns 222 can be spaced apart from adjacent light-blocking pattern 222. For example, a portion of the upper surface of the light-blocking substrate 221 can be exposed by the light-blocking patterns 222. The light-blocking patterns 222 can include a material having a high reflectance. For example, the light-blocking patterns 222 can include a metal.

The blue light emitted from each blue light-source 212 can be primarily diffused by the light-blocking sheet 220. For example, the light-blocking patterns 222 can overlap the blue light-sources 212. Blue light 212La emitted from each blue light-source 212 in a direction perpendicular to the upper surface of the light-source substrate 211 can be reflected toward the light-source substrate 211 by one of the light-blocking patterns 222.

The light-source unit 210 can include reflective patterns 213 disposed between the blue light-sources 212. Thus, in the display apparatus according to the embodiment of the present disclosure, blue light 213L reflected toward the light-source substrate 211 by the light-blocking patterns 222 can be reflected toward the light-blocking substrate 221 by the reflective patterns 213. At least some tion of the blue light reflected toward the light-blocking substrate 221 by the reflective patterns 213 can pass between the light-blocking patterns 222. For example, in the display apparatus according to the embodiment of the present disclosure, at least some and blue light 212Lb obliquely emitted based on a direction perpendicular to the upper surface of the light-source substrate 211 from each blue light-source 212 can pass between the light-blocking patterns 222. Therefore, in the display apparatus according to the embodiment of the present disclosure, the blue light 212La and 212Lb emitted from each blue light-source 212 can be diffused by the light-blocking patterns 222 and the reflective patterns 213, so that the blue light 212La and 212Lb emitted from each blue light-source 212 can pass through a region of the light-blocking substrate 221 overlapping with a region disposed between the blue light-sources 212.

Each of the light-blocking patterns 222 can have various shapes. For example, a portion of the blue light 212La emitted in a direction perpendicular to the upper surface of the light-source substrate 211 from each blue light-source 212 can pass the light-blocking pattern 222 overlapping with the corresponding blue light-source 212. That is, in the display apparatus according to the embodiment of the present disclosure, the blue light 222L passing through each light-blocking pattern 222, at least some of the blue light reflected by each reflective pattern 213, and the blue light 212Lb obliquely emitted based on a direction perpendicular to the upper surface of the light-source substrate 211 from each blue light-source 212 can pass the light-blocking sheet 220. Thus, in the display apparatus according to the embodiment of the present disclosure, the difference in the luminance between a region in which each blue light-source 212 is disposed and a region disposed between the blue light-sources 212 can be reduced.

The light-source unit 210 can include a light-source planarization layer 214 disposed on the blue light-sources 212 and the reflective patterns 213. The light-source planarization layer 214 can prevent the damage of the blue light-sources 212 and the reflective patterns 213 due to external impact. A portion of the light-source substrate 211 disposed between the blue light-sources 212 and the reflective patterns 213 can be in direct contact with the light-source planarization layer 214. For example, the blue light-sources 212 and the reflective patterns 213 can be completely covered by the light-source planarization layer 214. The light-source planarization layer 214 can include a material having a high transmittance. The light-source planarization layer 214 can include an adhesive material. For example, the light-source planarization layer 214 can include a curable resin. Thus, in the display apparatus according to the embodiment of the present disclosure, the blue light-sources 212 and the reflective patterns 213 can be fixed on the light-source substrate 211 by the light-source planarization layer 214. Therefore, in the display apparatus according to the embodiment of the present disclosure, the movement of the blue light-sources 212 and the reflective patterns 213 due to the external impact can be prevented.

The light-blocking substrate 221 can be spaced apart from the light-source planarization layer 214. For example, an air-gap can be disposed between the light-source planarization layer 214 and the light-blocking substrate 221. Thus, in the display apparatus according to the embodiment of the present disclosure, the damage of the blue light-sources 212 and the reflective patterns 213 due to the movement of the light-blocking sheet 220 can be prevented.

A blue emission sheet 230 can be disposed between the light-blocking sheet 220 and the display panel 100. The blue emission sheet 230 can include an emission sheet layer 231 and blue light-emitting elements 232. The emission sheet layer 231 can include a material having a high transmittance. For example, the emission sheet layer 231 can include a transparent resin. The emission sheet layer 231 can be disposed parallel to the light-blocking substrate 221. The blue light-emitting elements 232 can be dispersed within the emission sheet layer 231. For example, each of the blue light-emitting elements 232 can be surrounded by the emission sheet layer 231

Each of the blue light-emitting elements 232 can include core particle 232c and a blue light-emitting layer 232e. The blue light-emitting layer 232e can cover a surface of the core particle 232c. The blue light-emitting layer 232e can include a second blue emission material. The second blue emission material can generate blue light. For example, the second blue emission material can include a blue fluorescent material. Thus, in the display apparatus according to the embodiment of the present disclosure, the blue light-emitting layer 232e of each blue light-emitting element 232 can generate blue light 232L by using the blue light passing through the light-blocking sheet 220, and the blue light 232L generated by the blue light-emitting layer 232e of each blue light-emitting element 232 can be emitted in all directions. That is, in the display apparatus according to the embodiment of the present disclosure, the blue light passing through the light-blocking sheet 220 can be secondarily diffused in all directions by the blue emission sheet 230. The blue light diffused toward the light-blocking sheet 220 by each blue light-emitting element 232 can be reflected toward the blue emission sheet 230 by the light-blocking patterns 222. Therefore, in the display apparatus according to the embodiment of the present disclosure, the difference in the luminance of the blue light according to a viewing angle can be reduced.

The second blue emission material can include a same material as the first blue emission material. For example, in the display apparatus according to the embodiment of the present disclosure, the blue light 232L emitted in all directions by the blue light-emitting layer 232e of each blue light-emitting element 232 can have a wavelength range same as the blue light 212La and 212Lb emitted from each blue light-source 212. Thus, in the display apparatus according to the embodiment of the present disclosure, the changes in the color coordinates due to the blue emission sheet 230 can be prevented.

The core particle 232c of each blue light-emitting element 232 can be surrounded by the blue light-emitting layer 232e of the corresponding blue light-emitting element 232. The core particle 232c of each blue light-emitting element 232 can have a reflective index different from the blue light-emitting layer 232e of the corresponding blue light-emitting element 232. For example, the core particle 232c of each blue light-emitting element 232 can include an inorganic material. The core particle 232c of each blue light-emitting element 232 can include a material having a relative high reflectance. Thus, in the display apparatus according to the embodiment of the present disclosure, the blue light passing through the blue light-emitting layer 232e and the blue light emitted toward the core particle 232c from the blue light-emitting layer 232e can be reflected toward the blue light-emitting layer 232e in the surface of the core particle 232c. The blue light reflected in the surface of the core particle 232c can be diffused in all directions by the blue light-emitting layer 232e. Therefore, in the display apparatus according to the embodiment of the present disclosure, the efficiency of the blue light-emitting layer 232e can be improved.

A color conversion layer 240 can be disposed between the blue emission layer 230 and the display panel 100. The color conversion layer 240 can include a conversion sheet layer 241 and a plurality of light-emitting elements 242 and 243. The plurality of light-emitting elements 242 and 243 can be dispersed within the conversion sheet layer 241. The conversion sheet layer 241 can include a material having a high transmittance. For example, the conversion sheet layer 241 can include a transparent resin. Each of the light-emitting elements 242 and 243 can be surrounded by the conversion sheet layer 241. The conversion sheet layer 241 can include a same material as the emission sheet layer 231. The conversion sheet layer 241 can be disposed parallel to the emission sheet layer 231.

The color conversion sheet 240 can realize white light by using the blue light 232L emitted from each blue light-emitting element 232. For example, the plurality of light-emitting elements 242 and 243 can include red light-emitting elements 242 and green light-emitting elements 243, each of the red light-emitting elements 242 can generate red light 242L by using blue light 232L emitted from each blue light-emitting layer 2322, and each of the green light-emitting elements 243 can be generate green light 243L by using blue light 232L emitted from each blue light-emitting layer 232e. The red light-emitting elements 242 and the green light-emitting elements 243 can be mixed in the conversion sheet layer 241. For example, the white light by the color conversion sheet 240 can be realized by mixing the red light 242L by the red light-emitting elements 242, the green light 243L by the green light-emitting elements 243 and the blue light that is not absorbed by the red light-emitting elements 242 and the green light-emitting elements 243. The red light 242L of the red light-emitting elements 242 can be diffused in all directions. The green light 243L of the green light-emitting elements 243 can be diffused in all directions. Thus, in the display apparatus according to the embodiment of the present disclosure, the red light 242L generated by the red light-emitting elements 242 and the green light 243L generated by the green light-emitting elements 243 can be diffused in the same as the blue light 232L by the blue light-emitting element 232. That is, in the display apparatus according to the embodiment of the present disclosure, the difference in the luminance of the white light realized by mixing the blue light 232L generated by the blue light-emitting elements 232, the red light 242L generated by the red light-emitting elements 242, and the green light 243L generated by the green light-emitting elements 243 according to a viewing angle can be reduced. Therefore, in the display apparatus according to the embodiment of the present disclosure, the difference in the luminance of the white light provided to the display panel 100 passing through the color conversion sheet 240 can be reduced or minimized. And, in the display apparatus according to the embodiment of the present disclosure, the occurrence of spots due to the different in the luminance of the white light can be prevented.

Each of the red light-emitting elements 242 can include a red emission material generating red light. For example, the red emission material can include a red fluorescent material. Each of the red light-emitting elements 242 can have a different structure from each blue light-emitting element 232. For example, each of the red light-emitting elements 242 can be a particle made only of the red emission material.

Each of the green light-emitting elements 243 can include a green emission material generating green light. For example, the green emission material can include a green fluorescent material. Each of the green light-emitting elements 243 can have a different structure from each blue light-emitting element 232. Each of the green light-emitting elements 243 can have a same structure as each red light-emitting element 242. For example, each of the green light-emitting elements 243 can be a particle made only of the green emission material.

At least one optical sheet 250 can be disposed between the color conversion sheet 240 and the display panel 100. The at least one optical sheet 250 can be disposed parallel to the conversion sheet layer 241. For example, the white light by the color conversion sheet 240 can be provided to the entire area of the display panel 100 through the at least one optical sheet 250. The white light passing through the at least one optical sheet 250 can have uniform luminance as a whole. For example, the at least one optical sheet 250 can have a stacked structure of a diffusion sheet 251, a first prism sheet 252 and a second prism sheet 253.

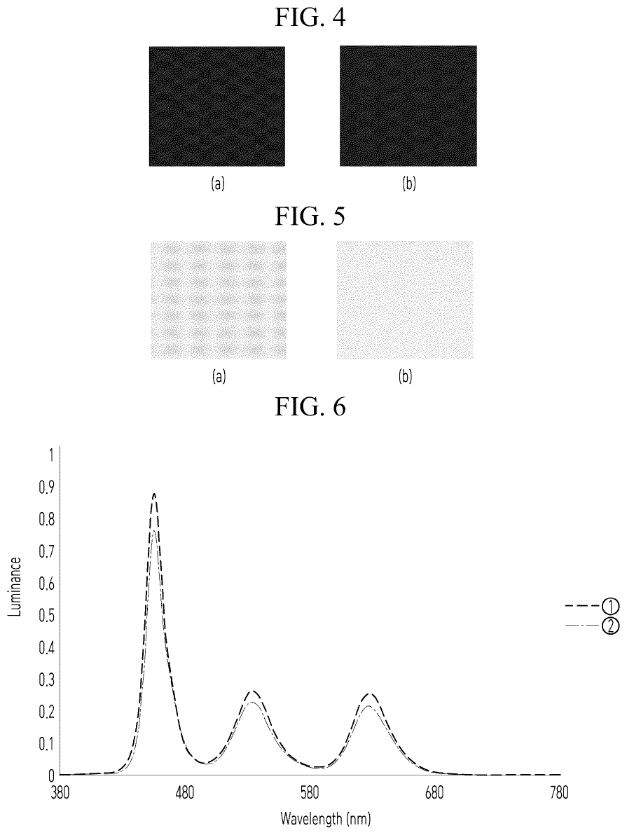

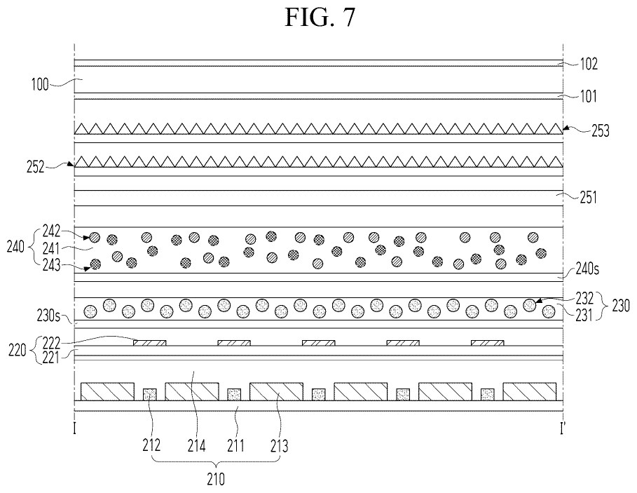

FIG. 4 is a photograph showing blue light provided to the display panel 100 from the back-light unit 200 in a comparative display apparatus a that does not include the blue emission sheet 240 and the display apparatus b according to the embodiment of the present disclosure. FIG. 5 is a photograph showing white light provided to the display panel 100 from the back-light unit 200 in a comparative display apparatus a that does not include the blue emission sheet 240 and the display apparatus b according to the embodiment of the present disclosure.

Referring to FIGS. 4 and 5, spots due to the difference in the luminance can be recognized in the blue color and the white color provided to the display panel 100 of the comparative display apparatus a that does not include the blue emission sheet 240, but the spots can't be displayed in the blue color and the white color provided to the display panel of the display apparatus b according to the embodiment of the present disclosure. That is, in the display apparatus according to the embodiment of the present disclosure, the red light 242L and the blue light 243L by the color conversion sheet 240 and the blue light 232L by the blue light-emitting elements 232 of the blue emission sheet 230 can be diffused in all directions, such that the difference in the luminance between a region in which each blue light-source 212 is disposed and a region disposed between the blue light-sources 212 can be significantly reduced. Thus, in the display apparatus according to the embodiment of the present disclosure, the occurrence of the spots due to the location of the blue light-sources 212 can be prevented. Therefore, in the display apparatus according to the embodiment of the present disclosure, the quality of the image provided to the user can be improved.

Accordingly, the display apparatus according to the embodiment of the present disclosure can include the display panel 100 disposed on the back-light unit 200, wherein the back-light unit 200 can include the blue light-sources 212 disposed parallel to the display panel 100, the color conversion sheet 240 disposed between the blue light-sources 212 and the display panel 100, the at least one optical sheet 250 disposed between the color conversion sheet 240 and the display panel 100, and the blue emission sheet 230 disposed between the blue light-sources 212 and the color conversion sheet 240, wherein the blue emission sheet 230 can include the blue light-emitting elements 232 dispersed within the emission sheet layer 231, and wherein each of the blue light-emitting elements 232 can include the blue light-emitting layer 232e covering the surface of the core particle 232c. Thus, in the display apparatus according to the embodiment of the present disclosure, the blue light 232L generated by the blue light-emitting elements 232 of the blue emission sheet 230 can be diffused in all directions. That is, in the display apparatus according to the embodiment of the present disclosure, the occurrence of the spots due to the location of the blue light-sources 212 can be prevented. Therefore, in the display apparatus according to the embodiment of the present disclosure, the difference in the luminance of the white light provided to the display panel 100 from the back-light unit 200 can be significantly reduced.

And, in the display apparatus according to the embodiment of the present disclosure, the difference in the luminance between a region in which each blue light-source 212 is disposed and a region disposed between the blue light-sources 212 can be significantly reduced by the blue light-emitting elements 232 of the blue emission sheet 230. Thus, in the display apparatus according to the embodiment of the present disclosure, an interval between the blue light-sources 212 can be increased. For example, in the display apparatus according to the embodiment of the present disclosure, the number of the blue light-sources 212 disposed on the light-source substrate 211 can be reduced. Therefore, in the display apparatus according to the embodiment of the present disclosure, the low power operation can be possible, and the power consumption can be reduced.

FIG. 6 is a graph showing the luminance of the first blue light \textcircled{1} diffused by the blue emission sheet 230 in which the blue emission material has a 5% content and the luminance of the second blue light \textcircled{2} diffused by the blue emission sheet 230 in which the blue emission material has a 10% content in the display apparatus according to the embodiment of the present disclosure.

Referring to FIG. 6, in the display apparatus according to the embodiment of the present disclosure, the luminance of the second blue light \textcircled{2} can be lower than the luminance of the first blue light \textcircled{1}. Thus, in the display apparatus according to the embodiment of the present disclosure, the content of the blue mission material within the blue emission sheet 230 can be more than 0% and less than 10%. Therefore, in the display apparatus according to the embodiment of the present disclosure, the luminance of the blue light 232L diffused by the blue emission sheet 230 can be maximized.

The display apparatus according to the embodiment of the present disclosure is described that the blue light-emitting layer 232e of each blue light-emitting element 232, the red light-emitting elements 242 and the green light-emitting elements 243 include a fluorescent material. However, in the display apparatus according to another embodiment of the present disclosure, at least one of the blue light-emitting layer 232e of each blue light-emitting element 232, the red light-emitting elements 242 and the green light-emitting elements 243 include a phosphorescence material. Thus, in the display apparatus according to another embodiment of the present disclosure, the degree of freedom in the material of the blue light-emitting layer 232e of each blue light-emitting element 232, the red light-emitting elements 242 and the green light-emitting elements 243 can be improved. And, in the display apparatus according to another embodiment of the present disclosure, the color reproduction of the white light provided to the display panel 100 from the back-light unit 200 can be improved.

The display apparatus according to the embodiment of the present disclosure is described that the second blue emission material of the blue light-emitting layer 232e is a same material as the first blue emission material of each blue light-source 212. However, in the display apparatus according to another embodiment of the present disclosure, the peak wavelength λmax of the blue light 232L generated by the blue light-emitting layer 232e can be different from the peak wavelength of the blue light 212La and 212Lb emitted from each blue light-source 212. For example, in the display apparatus according to another embodiment of the present disclosure, the peak of the blue light 232L generated by the blue light-emitting layer 232e can move toward a loner wavelength than the peak of the blue Light 212La and 212Lb emitted from each blue light-source 212. Thus, in the display apparatus according to another embodiment of the present disclosure, the color reproduction by the red light-emitting elements 242 and the green light-emitting elements 243 can be improved. And, in the display apparatus according to another embodiment of the present disclosure, the low blue light used in the image recognized by the user can be reduced. Therefore, in the display apparatus according to another embodiment of the present disclosure, the fatigue of the user recognizing the image due to the lower blue light can be reduced.

In the display apparatus according to another embodiment of the present disclosure, at least one of the blue emission sheet 230 and the color conversion sheet 240 can be supported by a sheet substrate. For example, in the display apparatus according to another embodiment of the present disclosure, the blue emission sheet 230 can be supported by a first sheet substrate 230s, and the color conversion sheet 240 can be supported by a second sheet substrate 240s. The first sheet substrate 230s and the second sheet substrate 240s can include a material having high transmittance. For example, the first sheet substrate 230s and the second sheet substrate 240s can include plastic. The second sheet substrate 240s can include a same material as the first sheet substrate 230s. For example, the first sheet substrate 230s and the second sheet substrate 240s can include a same material as the light-blocking substrate 221. Thus, in the display apparatus according to another embodiment of the present disclosure, the deformation of the blue emission sheet 230 and the color conversion sheet 240 due to the external impact can be prevented.

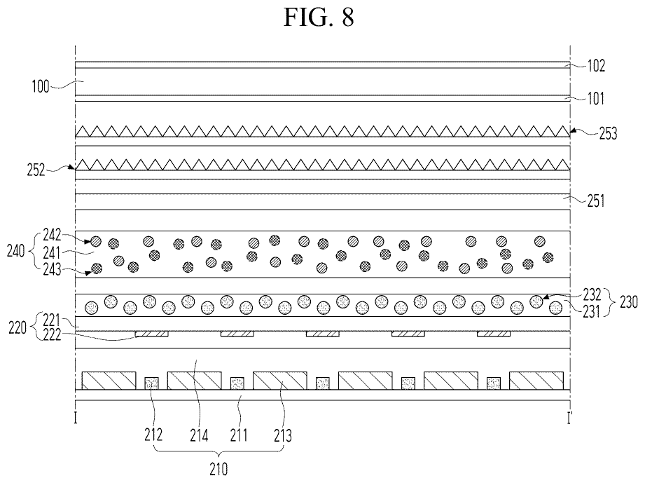

The display apparatus according to the embodiment of the present disclosure is described that the light-blocking substrate 221 is disposed between the light-source planarization layer 214 and the light-blocking patterns 222. However, in the display apparatus according to another embodiment of the present disclosure, the light-blocking substrate 221 and the light-blocking patterns 222 can be arranged in various ways. For example, in the display apparatus according to another embodiment of the present disclosure, the light-blocking patterns 222 can be disposed side by side on a lower surface of the light-blocking substrate 221 toward the light-source planarization layer 214, as shown in FIG. 8. The light-source planarization layer 214 can be spaced apart from the light-blocking patterns 222. For example, the light-blocking patterns 222 can be surrounded by an air-gap disposed between the light-source planarization layer 214 and the light-blocking substrate 221. Thus, in the display apparatus according to another embodiment of the present disclosure, the degree of freedom in the configuration of the light-blocking sheet 220 can be improved.

In the display apparatus according to another embodiment of the present disclosure, the emission sheet layer 231 of the blue emission sheet 230 can be in direct contact with the upper surface of the light-blocking substrate 221 opposite to the light-source planarization layer 214. That is, in the display apparatus according to another embodiment of the present disclosure, the blue emission sheet 230 can be supported by the light-blocking substrate 221. Thus, in the display apparatus according to another embodiment of the present disclosure, the deformation of the blue emission sheet 230 due to the external impact can be prevented by the light-blocking sheet 230.

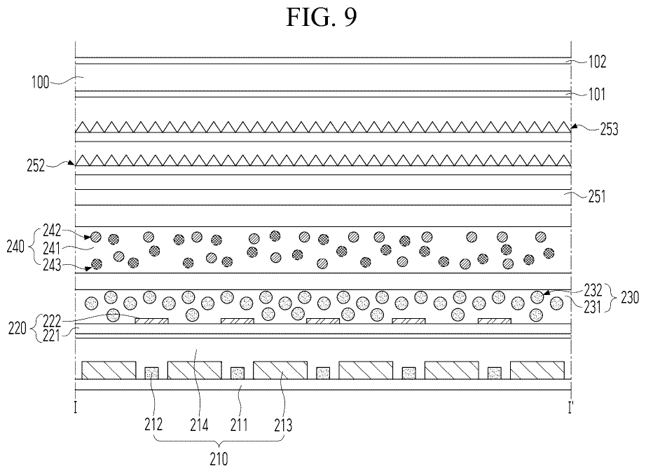

The display apparatus according to the embodiment of the present disclosure is described that the blue emission sheet 230 is spaced apart from the light-blocking patterns 222. However, in the display apparatus according to another embodiment of the present disclosure, the blue emission sheet 230 can be in direct contact with the light-blocking patterns 222. For example, in the display apparatus according to another embodiment of the present disclosure, the emission sheet layer 231 of the blue emission sheet 230 can be in direct contact with the light-blocking substrate 221 between the light-blocking patterns 222, as shown in FIG. 9. That is, in the display apparatus according to another embodiment of the present disclosure, the light-blocking patterns 222 can be completely covered by the emission sheet layer 231. Thus, in the display apparatus according to another embodiment of the present disclosure, the difference in the luminance of the blue light diffused in all directions by the blue light-emitting elements 232 can be effective reduced. Therefore, in the display apparatus according to another embodiment of the present disclosure, the difference in the luminance of the white light provided to the display panel 100 can be minimized.

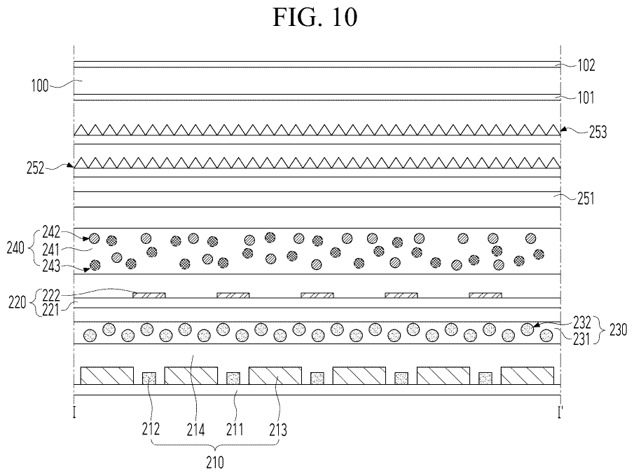

The display apparatus according to the embodiment of the present disclosure is described that the blue emission sheet 230 is disposed between the light-blocking sheet 220 and the color conversion sheet 240. However, in the display apparatus according to another embodiment of the present disclosure, the blue emission sheet 230 can be variously arranged between the blue light-sources 212 and the color conversion sheet 240. For example, in the display apparatus according to another embodiment of the present disclosure, the blue emission sheet 230 can be disposed between the light-source planarization layer 214 of the light-source unit 210 and the light-blocking sheet 220, as shown in FIG. 10. Thus, in the display apparatus according to another embodiment of the present disclosure, the blue light emitted toward the light-source substrate 211 by each blue light-emitting element 232 can be reflected toward the light-blocking sheet 220 by one of the reflective patterns 213. That is, in the display apparatus according to another embodiment of the present disclosure, the blue light by the blue emission sheet 230 can be provided to the color conversion sheet 240 at various angles. Therefore, in the display apparatus according to another embodiment of the present disclosure, the occurrence of the spot due to the location of the blue light-sources 212 can be effectively prevented.

In the display apparatus according to another embodiment of the present disclosure, the blue emission sheet 230 can be supported by the light-source unit 210. For example, in the display apparatus according to another embodiment of the present disclosure, the emission sheet layer 231 of the blue emission sheet 230 can be in direct contact with the upper surface of the light-source planarization layer 214 opposite to the light-source substrate 211. Thus, in the display apparatus according to another embodiment of the present disclosure, the damage of the blue light-sources 212 and the deformation of the blue emission sheet 230 due to the external impact can be effectively prevented.

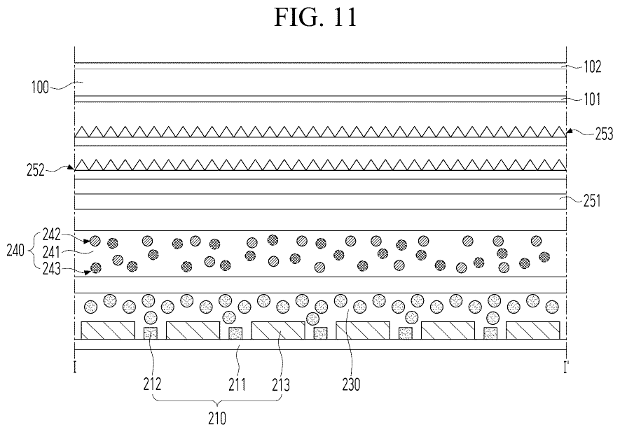

The display apparatus according to the embodiment of the present disclosure is described that the blue light-emitting elements 232 are dispersed within the emission sheet layer 231. However, in the display apparatus according to another embodiment of the present disclosure, the blue light-emitting elements 232 can be dispersed in various layers. For example, in the display apparatus according to another embodiment of the present disclosure, the blue light-emitting elements 232 can be dispersed within the light-source planarization layer 214, as shown in FIG. 11. Thus, in the display apparatus according to another embodiment of the present disclosure, the blue light emitted from each blue light-source 212 can be emitted in all directions by one of the blue light-emitting elements 232. The blue light emitted toward the light-source substrate 211 from each blue light-emitting element 232 can be reflected toward the color conversion sheet 240 by one of the reflective patterns 213. Therefore, in the display apparatus according to another embodiment of the present disclosure, the difference in the luminance of the blue light according to a viewing angle can be effectively reduced.

In the display apparatus according to another embodiment of the present disclosure, the light-blocking sheet 220 can be omitted. For example, an air-gap can be disposed between the light-source planarization layer 214 in which the blue light-emitting elements 232 are disposed and the color conversion layer 240. Thus, in the display apparatus according to another embodiment of the present disclosure, the degree of freedom in the configuration of the back-light unit can be improved. And, in the display apparatus according to another embodiment of the present disclosure, the overall thickness of the back-light unit can be reduced.

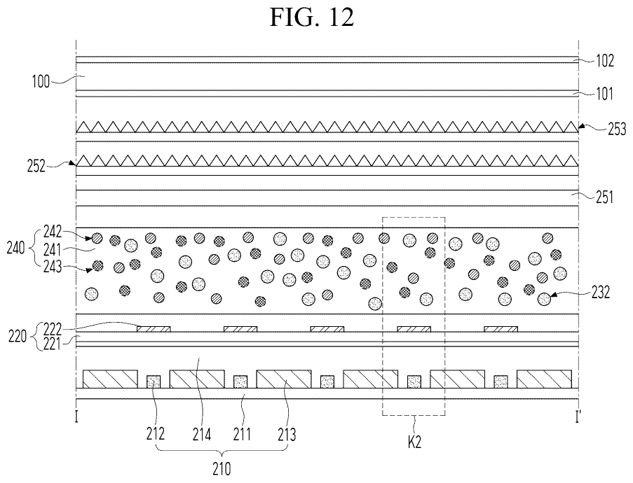

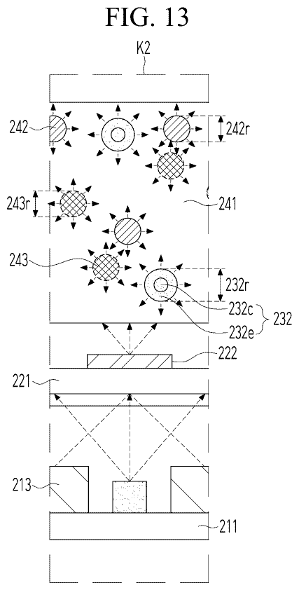

The display apparatus according to the embodiment of the present disclosure is described that the blue light-emitting elements 232 is dispersed in a different layer from the red light-emitting elements 242 and the green light-emitting elements 243. However, in the display apparatus according to another embodiment of the present disclosure, the blue light-emitting elements 232, the red light-emitting elements 242 and the green light-emitting elements 243 can be dispersed within a single layer. For example, in the display apparatus according to another embodiment of the present disclosure, the blue light-emitting elements 232 can be dispersed in the conversion sheet 240, e.g. in the conversion sheet layer 241 of the color conversion sheet 240, as shown in FIGS. 12 and 13. That is, in the display apparatus according to another embodiment of the present disclosure, the color conversion sheet 240 can include the blue light-emitting elements 232, the red light-emitting elements 242 and the green light-emitting elements 243. Thus, in the display apparatus according to another embodiment of the present disclosure, the overall thickness can be reduced.

A diameter 232r of each blue light-emitting element 232 can be larger than a diameter 242r of each red light-emitting element 242 and a diameter 243r of each green light-emitting elements 243 by the blue light-emitting layer 232e surrounding the core particle 232c. Thus, in the display apparatus according to the embodiment of the present disclosure, an emission area of the blue light generated by the blue light-emitting layer 232e of each blue light-emitting element 232 can be sufficiently secured. For example, in the display apparatus according to another embodiment of the present disclosure, the blue light emitted from each blue light-emitting element 232 can have the amount of light same as the red light emitted from each red light-emitting element 242 and the green light emitted from each green light-emitting element 243. Therefore, in the display apparatus according to another embodiment of the present disclosure, the difference in the luminance between a region in which each blue light-source 212 is disposed and a region between the blue light-sources 212 can be minimized.

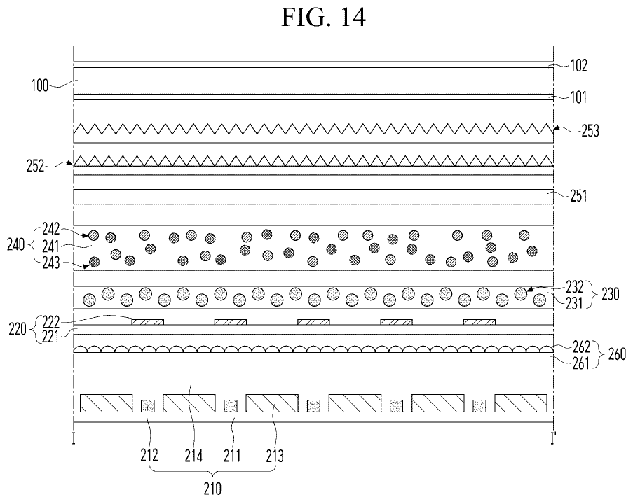

The display apparatus according to the embodiment of the present disclosure is described that the at least one optical sheet 250 disposed between the color conversion sheet 240 and the display panel 100 includes a diffusion sheet 251. However, in the display apparatus according to another embodiment of the present disclosure, the diffusion sheet 251 can be arranged in various locations. And, the display apparatus according to another embodiment of the present disclosure can include a plurality of diffusion sheets 251. For example, in the display apparatus according to another embodiment of the present disclosure, the diffusion sheet 251 can be disposed between the color conversion sheet 240 and the display panel 100, and a light-source diffusion sheet 260 (also referred to as diffusion plate herein) can be disposed between the light-source planarization layer 214 and the light-blocking sheet 220, as shown in FIG. 14.

The light-source diffusion sheet 260 can include a diffusion substrate 261 and diffusing patterns 262 (also referred to as diffusion beads herein). The diffusion substrate 261 can include a material having high transmittance. For example, the diffusion substrate 261 can include plastic. The diffusion substrate 261 can include a same material as the light-blocking substrate 221. The diffusion substrate 261 can be disposed parallel to the light-blocking substrate 221.

The diffusing patterns 262 can be disposed on a surface of the diffusion substrate 261. For example, the diffusing patterns 262 can be disposed on an upper surface of the diffusion substrate 262 toward the light-blocking substrate 220. At least one of the diffusing patterns 262 can be in direct contact with the diffusion substrate 261. For example, the diffusing patterns 262 can be dispersed in the upper surface of the diffusion substrate 261.

Each of the diffusing patterns 262 can have a hemi-spherical shape. For example, a cross-section of each diffusing pattern 262 can have a semi-circular shape. Light passing through the diffusion substrate 261 can be refracted by the diffusing patterns 262. For example, a surface of each diffusing pattern 262 opposite to the diffusion substrate 261 can have a convex shape. Thus, in the display apparatus according to another embodiment of the present disclosure, the light emitted toward the display panel 100 from the light-source unit 210 can be diffused by the diffusing patterns 262. That is, in the display apparatus according to another embodiment of the present disclosure, the light emitted from the light-source unit 210 can be evenly provided to an entire area of the light-blocking sheet 220 by the light-source diffusion sheet 260. Therefore, in the display apparatus according to another embodiment of the present disclosure, the occurrence of the spots due to the location of the blue light-sources 212 can be effectively prevented.

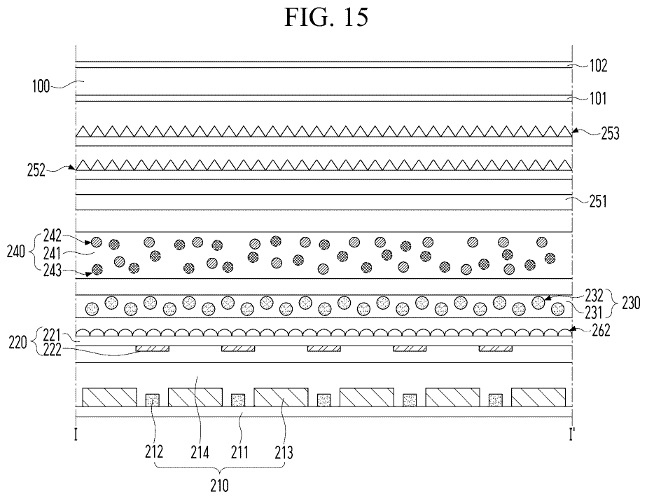

In the display apparatus according to another embodiment of the present disclosure, the diffusing patterns 262 can be in direct contact with the light-blocking substrate 221. For example, in the display apparatus according to another embodiment of the present disclosure, the light-blocking patterns 222 can be disposed side by side on the lower surface of the light-blocking substrate 261, and the diffusing patterns 262 can be dispersed on the upper surface of the light-blocking substrate 221, as shown in FIG. 15. Thus, in the display apparatus according to another embodiment of the present disclosure, the diffusion substrate 261 can be omitted. And, in the display apparatus according to another embodiment of the present disclosure, the light passing through the light-blocking sheet 220 can be diffused by the diffusing patterns 262. That is, in the display apparatus according to another embodiment of the present disclosure, the light passing through the light-blocking sheet 220 can be evenly supplied to the entire area of the blue emission sheet 230 by the diffusing patterns 262. Therefore, in the display apparatus according to another embodiment of the present disclosure, the occurrence of the spots due to the location of the blue light-sources 212 can be prevented, and the increase of the overall thickness due to the diffusing patterns 262 can be reduced.

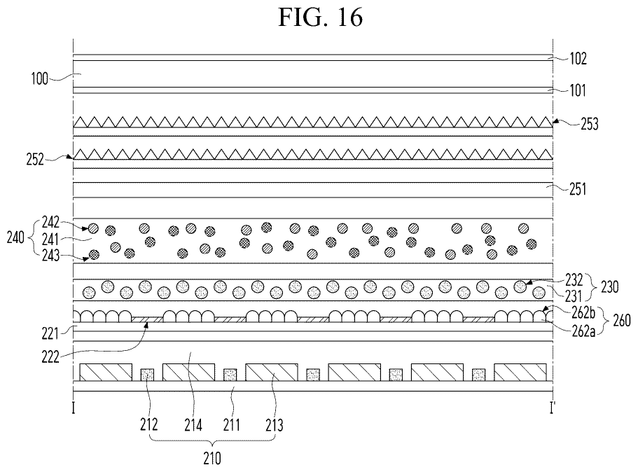

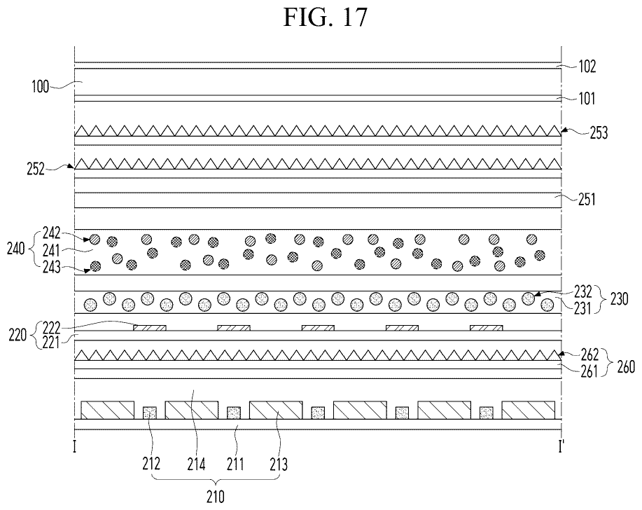

In the display apparatus according to another embodiment of the present disclosure, the light-blocking patterns 222 and the diffusing patterns 262 can be disposed on a same surface of the light-blocking substrate 221. For example, in the display apparatus according to another embodiment of the present disclosure, the diffusing patterns 262 and the light-blocking patterns 222 can be disposed on the upper surface of the light-blocking substrate 221, as shown in FIG. 16. The diffusing patterns 262 can be disposed between the light-blocking patterns 222. For example, at least some of the diffusing patterns 262 can be in direct contact with the upper surface of the light-blocking substrate 221 between the light-blocking patterns 222.

Each of the diffusing patterns 262 can have a larger thickness than the light-blocking patterns 222. For example, each of the diffusing patterns 262 can include a lower pattern 262a disposed between the light-blocking patterns 222 and an upper pattern 252b being in contact with an upper surface of the lower pattern 262a opposite to the light-blocking substrate 221. A side surface of each light-blocking pattern 222 can be in direct contact with the lower pattern 262a of one of the diffusing patterns 262. A surface of the upper pattern 262b opposite to the light-blocking substrate 221 can have a convex shape toward the blue emission sheet 230. Thus, in the display apparatus according to another embodiment of the present disclosure, the light passing between the light-blocking patterns 222 can be diffused by the diffusing patterns 262. Therefore, in the display apparatus according to another embodiment of the present disclosure, the increase of the overall thickness due to the diffusing patterns 262 can be minimized, and the occurrence of the spots due to the location of the blue light-sources 212 can be effectively prevented.

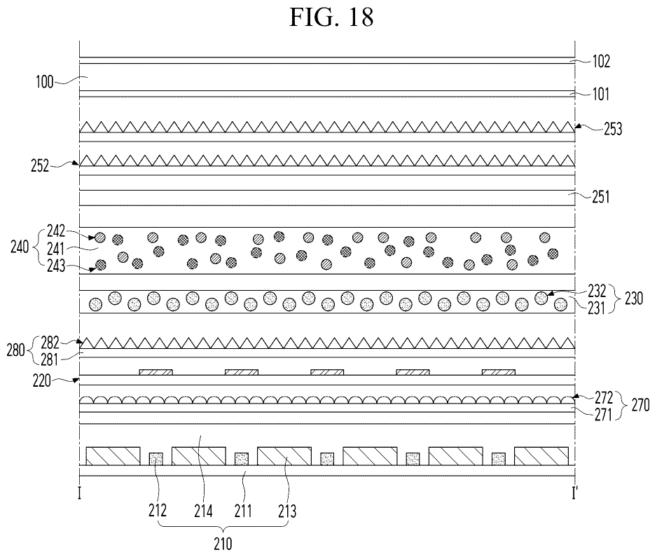

In the display apparatus according to another embodiment of the present disclosure, each of the diffusing patterns 262 can have various shapes. In the display apparatus according to another embodiment of the present disclosure, a cross-section of each diffusing pattern 262 can have a polygonal shape. For example, in the display apparatus according to the embodiment of the present disclosure, a cross-section of each diffusing pattern 262 can have a triangular shape, as shown in FIG. 17. A lower surface of each diffusing pattern 262 toward the diffusion substrate 261 can be a flat. For example, in the display apparatus according to another embodiment of the present disclosure, the light-source diffusion sheet 260 can have a same shape as the first prism sheet 252 or the second prism sheet 252 included in the at least one optical sheet 250. Thus, in the display apparatus according to another embodiment of the present disclosure, the light supplied to the entire area of the blue emission sheet 230 can have uniform luminance by the light-source diffusion sheet 260. Therefore, in the display apparatus according to another embodiment of the present disclosure, the difference in the luminance of the light provided to the display panel 100 can be effectively reduced.

In the display apparatus according to another embodiment of the present disclosure, a plurality of diffusion sheet can be arranged between the light-source unit 210 and the blue emission sheet 230. For example, in the display apparatus according to another embodiment of the present disclosure, a lower diffusion sheet 270 can be disposed between the light-source planarization layer 214 and the light-blocking sheet 220, and an upper diffusion sheet 280 can be disposed between the light-blocking sheet 220 and the blue emission sheet 230, as shown in FIG. 18. The lower diffusion sheet 270 can include a lower substrate 271 and lower patterns 272. The upper diffusion sheet 280 can include an upper substrate 281 and upper patterns 282.

The lower substrate 271 and the upper substrate 281 can include a material having a high transmittance. For example, the lower substrate 271 and the upper substrate 281 can include plastic. The upper substrate 281 can include a same material as the lower substrate 271. The upper substrate 281 can be disposed parallel to the lower substrate 271.

The lower patterns 272 can be disposed on a surface of the lower substrate 271. For example, the lower patterns 272 can be dispersed in an upper surface of the lower substrate 271 toward the light-blocking sheet 220. At least some of the lower patterns 272 can be in direct contact with the upper surface of the lower substrate 271. The upper patterns 282 can be disposed on a surface of the upper substrate 281. For example, the upper patterns 282 can be dispersed in an upper surface of the upper substrate 281 toward the blue emission sheet 230. At least some of the upper patterns 282 can be in direct contact with the upper surface of the upper substrate 281. The lower patterns 272 and the upper patterns 282 can include a material that can refract light passing through it. The upper patterns 282 can include a same material as the lower patterns 272.

Each of the upper patterns 282 can have a different shape from each lower pattern 272. For example, a cross-section of each lower pattern 272 can have a semi-circular shape, and a cross-section of each upper pattern 282 can have a triangular shape. Thus, in the display apparatus according to another embodiment of the present disclosure, the light provided to the entire area of the blue emission sheet 230 through the lower diffusion sheet 270 and the upper diffusion sheet 280 can have uniform luminance. Therefore, in the display apparatus according to another embodiment of the present disclosure, the difference in the luminance of the light provided to the entire area of the display panel 100 from the light-source unit 210 can be effectively reduced.

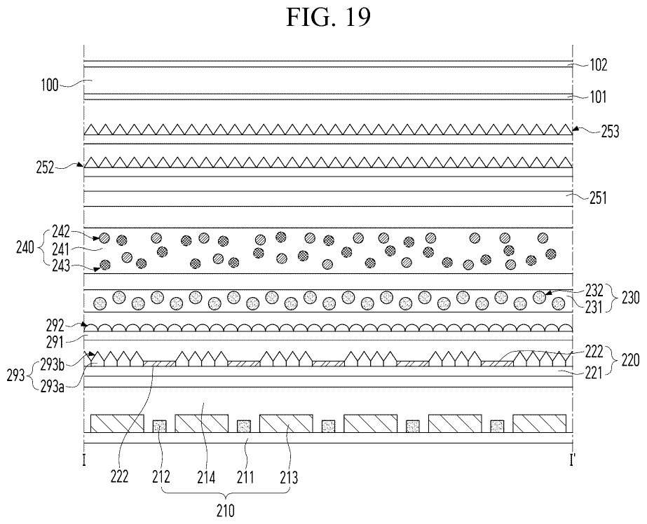

In the display apparatus according to another embodiment of the present disclosure, the lower patterns 272 and the upper patterns 282 can be arranged in various locations. For example, in the display apparatus according to another embodiment of the present disclosure, a light-source diffusion substrate 291 can be disposed between the light-blocking sheet 220 and the blue emission sheet 230, and first patterns 292 can be disposed side by side in an upper surface of the light-source diffusion substrate 291 toward the blue emission sheet 230, and second patterns 293 can be disposed between the light-blocking patterns 222, as shown in FIG. 19.

The second patterns 293 can include a different material from the first patterns 292. The second patterns 293 can have a different shape from the first patterns 292. For example, a cross-section of each first pattern 292 can have a semi-circular shape, and a cross-section of each second pattern 293 can have a polygonal shape. Each of the second patterns 293 can include a lower diffusing pattern 293a disposed between the light-blocking patterns 222 and an upper diffusing pattern 293b being in contact with an upper surface of the lower diffusing pattern 293a opposite to the light-blocking substrate 221. A side surface of each light-blocking pattern 222 can be in direct contact with the lower diffusing pattern 293a of one of the second patterns 293. Thus, in the display apparatus according to another embodiment of the present disclosure, the light provided to the entire area of the blue emission sheet 230 from the light-source unit 210 can have uniform luminance. Therefore, in the display apparatus according to another embodiment of the present disclosure, the difference in the luminance of the light provided to the entire area of the display panel 100 can be effectively reduced.

In the result, the display apparatus according to the embodiments of the present disclosure can comprise the display panel disposed on the back-light unit, wherein the back-light unit can include the blue light-sources disposed side by side, the color conversion sheet disposed between the blue light-sources and the display panel, the at least one optical sheet disposed between the color conversion sheet and the display panel, and the blue emission sheet disposed between the blue light-sources and the color conversion sheet, wherein the light-emitting elements dispersed within the color conversion sheet can emit light displaying a color other than the blue color in all directions by using the blue light emitted from the blue light-sources, and wherein the blue light can be diffused in all directions by the blue light-emitting elements dispersed in the blue emission sheet. Thus, in the display apparatus according to the embodiments of the present disclosure, the occurrence of the spots due to the location of the blue light-sources emitting light toward the display panel can be prevented. And, in the display apparatus according to the embodiments of the present disclosure, the difference in the luminance of the white light supplied to the display panel from the back-light unit can be reduced or minimized. Thereby, in the display apparatus according to the embodiments of the present disclosure, the quality of the image realized by the display panel can be improved. That is, in the display apparatus according to the embodiments of the present disclosure, the low power operation can be possible, and the power consumption can be reduced.

It will be apparent to those skilled in the art that various modifications and variations can be made in the display apparatus of the present disclosure without departing from the technical idea or scope of the disclosure. Thus, it is intended that the present disclosure cover the modifications and variations of this disclosure provided they come within the scope of the appended claims and their equivalents.

What is claimed is:

1. A display apparatus, comprising:
a light-source unit including blue light-sources, which are disposed side by side;
a light-blocking sheet including light-blocking patterns;
a color conversion sheet on the blue light-sources of the light-source unit;
at least one optical sheet on the color conversion sheet;
a display panel on the at least one optical sheet; and
a diffusion plate including a plurality of diffusion patterns,
wherein the color conversion sheet includes blue light-emitting elements,
wherein the distance between adjacent blue light-sources is higher than the distance between two adjacent light-blocking patterns, and
wherein the light-blocking patterns overlap the blue light-sources.

2. The display apparatus of claim 1, wherein diffusion plate is disposed between the blue light-sources of the light-source unit and the light-blocking sheet.

3. The display apparatus according to claim 1, wherein the light-emitting layer includes a blue emission material and a core particle surrounded by the blue light-emitting layer.

4. The display apparatus according to claim 3, wherein the blue emission material includes a blue fluorescent material.

5. The display apparatus according to claim 1, wherein the distance between adjacent blue light-sources is higher than 4 mm.

6. The display apparatus according to claim 1, wherein the light-source unit includes reflective patterns disposed between the blue light-sources.

7. The display apparatus according to claim 6, wherein the distance between two adjacent light-blocking patterns is smaller than the width of the reflective patterns.

8. The display apparatus according to claim 1, wherein the diffusion patterns overlap the reflective patterns.

9. The display apparatus according to claim 1, wherein the diffusion patterns overlap the blue light-source.

10. The display apparatus according to claim 1, wherein the diffusion patterns overlap the light-blocking patterns.

11. The display apparatus according to claim 1, wherein the color conversion sheet overlaps the diffusion patterns.

12. The display apparatus according to claim 1, wherein the color conversion sheet includes red light-emitting elements made of a red emission material and green light-emitting elements made of a green emission material.

13. The display apparatus according to claim 12, wherein the red emission material includes a red fluorescent material.

14. The display apparatus according to claim 12, wherein the green emission material includes a green fluorescent material.

15. The display apparatus according to claim 3, wherein the blue emission material contained in the color conversion sheet has a content of more than 0% and less than 10%.

16. The display apparatus according to claim 1, wherein the light-source unit includes a light-source planarization layer covering the blue light-sources, and
wherein the color conversion sheet is spaced apart from the light-source planarization layer.

17. The display apparatus according to claim 16, wherein the light-blocking sheet is disposed between the light-source planarization layer and the color conversion sheet,
wherein the light-blocking sheet includes light-blocking patterns overlapping with the blue light-sources and a light-blocking substrate supporting the light-blocking patterns, and
wherein the light-blocking patterns of the light-blocking sheet are covered by the color conversion sheet.
